(19) United States
(12) Patent Application Publication
(10) Pub. No.: US 2002/0098014 A1
(43) Pub. Date: Jul. 25, 2002

(54) Rotating force transmitting apparatus and image forming apparatus equipped with the same

(75) Inventor: Makoto Kitahara, Chiba (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/044,938

(22) Filed: Jan. 15, 2002

(30) Foreign Application Priority Data
Jan. 19, 2001 (JP) 2001-011211

(51) Int. Cl. G03G 15/06

(52) U.S. Cl. 399/222

(57) ABSTRACT

A rotating force transmitting apparatus includes: a first and a second transmitting devices for transmitting rotating forces to a first and a second rotary members, wherein the first and the second transmitting devices include a first and a second clutches for intermittently transmitting the rotating forces; a common driving device for imparting the rotating forces to the first and the second transmitting devices, wherein the second clutch can be switched from the turned-off state thereof to the turned-on state thereof for rotating the second rotary member when the first rotary member is rotating with the first clutch being turned on; and a permitting device for permitting the transmission of a rotating force only in a normal rotational direction of the driving device to the first transmitting device.

### BACKGROUND OF THE INVENTION

1. Field of the Invention

The present invention relates to a rotating force transmitting apparatus for transmitting a rotating force and an image forming apparatus such as a copying machine, a printer, a facsimile machine, and the like that is equipped with the rotating force transmitting apparatus and employs an electrophotographic process, an electrostatic recording process or the like.

2. Description of Related Art

The principal part of a full color electrostatic copying machine being an example of an image forming apparatus equipped with a rotating force transmitting apparatus will be described.

The full color electrostatic copying machine records an image having a plurality of colors on a recording medium by means of a digital image printer portion (hereinafter referred to as a “printer portion”) on the basis of image information from a color image reader portion (hereinafter referred to as a “reader portion”) for reading the image information on an original.

As shown in FIG. 5, in the printer portion, a pre-exposure lamp 11, a corona charger 2, a laser exposure optical system (not shown), a Y-developing unit 4y, a C-developing unit 4c, an M-developing unit 4m and a Bk-developing unit 4Bk being four developing devices for different colors, means 13 for detecting a quantity of light on the photosensitive drum 1, a transferring apparatus (not shown), a cleaning device 6 and the like are disposed around the photosensitive drum 1 being a latent image bearing member. The Y-developing unit 4y is a developing unit for yellow. The C-developing unit 4c is a developing unit for cyan. The M-developing unit 4m is a developing unit for magenta. The Bk-developing unit 4Bk is a developing unit for black.

When an image is formed by the printer portion, the charger 2 uniformly charges the photosensitive drum 1 after the photosensitive drum 1 has rotated in the direction indicated by the arrow to eliminate residual charges on the outer periphery of the photosensitive dram 1 with the pre-exposure lamp 11. Then, light images E are irradiated on the photosensitive drum 1 so that latent images of respective separated colors of the light images E are formed on the photosensitive drum 1.

Next, the latent images on the photosensitive drum 1 are developed by the operations of the developing units 4y, 4c, 4m and 4Bk corresponding to each separated color, and the images of toner being a powder developer having a base composed of a resin and a pigment are formed on the photosensitive drum 1. Incidentally, the developing units 4y, 4c, 4m and 4Bk are configured to approach the photosensitive drum 1 alternatively correspondingly to each separated color by the operations of respective eccentric cams 24y, 24c, 24m and 24Bk.

On the other hand, a recording material being a recording medium contained in a recording-material cassette (not shown) is fed to a transferring portion formed between the photosensitive drum 1 and the transferring apparatus (not shown) by the conveying system of the electrostatic copying machine, and the toner images on the photosensitive drum 1 are transferred on the recording material by the transferring apparatus. After that, the recording material on which the color image is formed is delivered to the outside.

The rotating force transmitting apparatus 100 for rotating each of the developing units 4y, 4c, 4m and 4Bk for each color will be described.

FIG. 6 is an expanded view of the rotating force transmitting apparatus 100. A rotating force from a drive motor (not shown) is transmitted to an input pulley 102, an input shaft 103 and a distributing gear 104 by a timing belt 101. The distributing gear 104 engages with an M-clutch gear 109m, a C-clutch gear 109c and idler gears 105 and 107. A rotating force from the idler gear 105 is transmitted to a Bk-clutch gear 109Bk through the idler gear 106, and a rotating force form the idler gear 107 is transmitted to a Y-clutch gear 109y through the idler gear 108.

Now, when an M-clutch 110m is turned on, the M-developing unit 4m is rotated through an output shaft 111m, an output gear 112m and a sleeve gear 113m. Similarly, when a C-clutch 110c is turned on, the C-developing unit 4c is rotated through an output shaft 111c, an output gear 112c and a sleeve gear 113c. When a Y-clutch 110y is turned on, the Y-developing unit 4y is rotated through an output shaft 111y, an output gear 112y and a sleeve gear 113y. When a Bk-clutch 110Bk is turned on, the Bk-developing unit 4Bk is rotated through an output shaft 111Bk, an output gear 112Bk and a sleeve gear 113Bk. A pair of supporting plates 114 and 115 supports the input shaft 103 and the output shafts 111m, 111c, lily and 111Bk rotatably.

The operations of the pressure of each of the developing units 4y, 4c, 4m and 4Bk, clutching timing and the like will be described.

The operations will be described with reference to the timing charts of FIG. 7, FIG. 8 and FIG. 9. Hereupon, concrete numerical values are set for making the descriptions of the operations easy to understand. Incidentally, the numerical values are for the sake of reference, and the related art is not restricted to the numerical values.

The diameter of the photosensitive drum 1 is set at 180 mm, and the peripheral speed (or the image-forming process speed) of the photosensitive drum 1 is set at 200 mm/sec. The developing units 4y, 4c, 4m and 4Bk are disposed around the photosensitive drum 1 within an angular range of 0 degrees to 100 degrees with respect to a horizontal direction in the clockwise direction equidistantly (at the interval of 33.3 degrees) in the order of yellow (Y), cyan (C), magenta (M) and black (Bk). The order of developing is M, C, Y and Bk.

A case where an image of the A-4 size is continuously copied in a full color copying mode will be described.

Abscissa axes of the timing charts shown in FIG. 7 to FIG. 9 indicate time (or distance). FIG. 9 is an enlarged view of the M-developing operation shown in FIG. 7 and FIG. 8. The waveforms in the top row to the third row in FIGS. 7 and 8 indicate latent images on the photosensitive drum 1 at the M-developing position, the pressuring operation of the M-developing unit 4m to the latent images, and the on-off actions of the M-clutch 110m, respectively. Because the latent images for two prints are formed on the photosensitive drum 1 during the rotation of the photosensitive drum 1 in the A-4 continuous copying mode, a reference mark M1 designates a latent image of magenta in the copy on the first sheet, and a reference mark M2 designates a latent image of magenta in the copy on the second sheet.

Similarly, the waveforms in the fourth row to the sixth row in FIG. 7 indicate latent images on the photosensitive drum 1 at the C-developing position, the pressuring operation of the C-developing unit 4c, and the actions of the C-clutch 110c, respectively. The waveforms in the seventh row to the ninth row in FIG. 7 indicate latent images on the photosensitive drum 1 at the Y-developing position, the pressuring operation of the Y-developing unit 4y, and the actions of the Y-clutch 110y, respectively. The waveforms in the tenth row to the twelfth row in FIG. 7 indicate latent images on the photosensitive drum 1 at the Bk-developing position, the pressuring operation of the Bk-developing unit 4Bk, and the actions of the Bk-clutch 110Bk, respectively.

The formation of the latent images is started. The latent image of each color is equidistantly formed on the outer periphery of the photosensitive drum 1 having the diameter of 180 mm for two prints of the A-4 size. Because the length of the outer periphery of the photosensitive drum 1 is about 565.2 mm and the width of the A-4 size is 210 mm, the interval of the latent images is 72.6 mm from the calculation of: (565.2-210×2)2=72.6 mm. The time of the interval of the latent images is 0.363 second from the calculation of: 72.6 (mm)÷200 (mm/second)=0.363 second.

The pressurization of the M-developing unit 4m to the photosensitive drum 1 is begun before 0.25 second short of (before 50 mm short of a position at) a point of time when the leading edge of the latent image M1 reaches the M-developing position. After 0.05 second (behind 10 mm) from the beginning of the pressure-contact of the M-developing unit 4m with the photosensitive drum 1, the M-clutch 110m is turned on as shown in FIG. 9. After 0.05 second (behind 10 mm) from the turning on of the M-clutch 10m, the peripheral speed of the M-developing unit 4m reaches a predetermined speed.

The development sleeve of the M-developing unit 4m is required to rotate at the predetermined peripheral speed before the completion of the pressure-contact of the development sleeve to the photosensitive drum 1. When the development sleeve does not rotate at the predetermined peripheral speed at the time of the pressure-contact thereof, there is a case where images are disturbed owing to the generation of “adherent fogging” being a phenomenon such that unnecessary toner adheres on the photosensitive drum 1.

After 0.15 second, or behind 30 mm, from the beginning of the pressure-contact of the M-developing unit 4m to the photosensitive drum 1, the pressure-contact of the M-developing unit 4m to the photosensitive drum 1 is completed. At this time, the development sleeve of the M-developing unit 4m rotates at the predetermined peripheral speed as described above.

Moreover, the M-developing unit 4m completes the pressure-contact to the photosensitive drum 1 with a clearance of the time of 0.1 second, or the distance of 20 mm, before the leading edge of the latent image M1. Then, the latent images M1 and M2 are developed.

After 0.1 second (behind 20 mm) from the completion of the development of the latent image M2, the M-developing unit 4m begins to separate from the photosensitive drum 1. The development sleeve of the M-developing unit 4m is also required to rotate at the predetermined peripheral speed when the M-developing unit 4m separates from the photosensitive drum 1 similarly at the time of the pressure-contact thereof. When the development sleeve is not rotating at the predetermined peripheral speed, the “fogging” is generated. In this case, when the M-developing unit 4m separates from the photosensitive drum 1, the M-clutch 110m is in a turned-on state thereof. Consequently, the “fogging” is not generated. After 0.05 second (behind 10 mm) from the beginning of the separation of the M-developing unit 4m, the M-clutch 110m turns off.

After 0.05 second (behind 10 mm) from the turning off of the M-clutch 110m, the M-developing unit 4m completely stops.

After 0.15 second (behind 30 mm) from the beginning of the separation operation of the M-developing unit 4m, the separation operation thereof is completed. The separation operation should be completed before the arrival of the next latent image C1 at the M-developing position. When the separation operation is not completed at the time of the arrival of the next latent image C1, there is the possibility that the latent image C1 of cyan is developed by the M-developing unit 4m.

In this example, the separation is completed with a clearance of the time of 0.113 second (a clearance of the distance of 22.6 mm) before the leading edge of the latent image C1 of cyan.

Next, the operation of the C-developing unit 4c will be described.

The C-developing unit 4c is disposed upstream of the M-developing unit 4m by the 33.3 degrees in the rotational direction of the photosensitive drum 1. Consequently, a latent image on the photosensitive drum 1 arrives at the C-developing position earlier than the arrival thereof at the M-developing position by the distance of: 180×π×(33÷360)=51.81 mm≈52 mm, namely by the time of: 51.81÷200=0.259 second≈0.26 second. Because the timing charts shown in FIG. 7 and FIG. 8 are drawn by the use of the same time axes, the latent images at the C-developing position are shifted to the left side in the timing chart of FIG. 7 by the 0.26 second (by the 52 mm).

The operation of the C-developing unit 4c is similar to that of the M-developing unit 4m.

After 0.113 second (behind 22.6 mm) from the passing through of the trailing edge of the latent image M2 at the C-developing position, the pressure-contact of the C-developing unit 4c to the photosensitive drum 1 is begun. After 0.05 second (behind 10 mm) from the beginning of the pressure-contact of the C-developing unit 4c to the photosensitive drum 1, the C-clutch 110c turns on.

After 0.05 second (behind 10 mm) from the turning on of the C-clutch 110c, the peripheral speed of the C-developing unit 4c reaches the predetermined peripheral speed. After 0.15 second (behind 30 mm) from the beginning of the pressure-contact of the C-developing unit 4c to the photosensitive drum 1, the pressure-contact of the C-developing unit 4c to the photosensitive drum 1 is completed. At this time, the C-developing unit 4c has reached the predetermined peripheral speed, and the pressure-contact of the C-developing unit 4c is completed with a clearance of the time of 0.1 second (the clearance of the distance of 20 mm) before the leading edge of the latent image C1. Then the latent image C1 and a latent image C2 are developed.

After 0.1 second (behind 20 mm) from the completion of the development of the latent image C2, the C-developing unit 4c begins to separate from the photosensitive drum 1.

After 0.05 second (behind 10 mm) from the beginning of the separation of the C-developing unit 4c, the C-clutch 110c turns off. After 0.05 second (behind 10 mm) from the turning off of the C-clutch 110c, the C-developing unit 4c completely stops.

After 0.15 second (behind 30 mm) from the beginning of the separation operation of the C-developing unit 4c, the C-developing unit 4c completes its separation operation. At this time, the separation of the C-developing unit 4c is completed with a clearance of the time of 0.113 second (a clearance of the distance of 22.6 mm) to the leading edge of the following latent image Y1.

Similarly, the Y-developing unit 4y is disposed upstream of the C-developing unit 4c by the 33.3 degrees in the rotational direction of the photosensitive drum 1. Consequently, latent images at the Y-developing position are shifted to the left side in the timing chart of FIG. 7 by the 0.261 second (by the 52 mm).

The operation of the Y-developing unit 4y is similar to those of the M-developing unit 4m and the C-developing unit 4c.

Moreover, the Bk-developing unit 4Bk is disposed downstream of the Y-developing unit 4y by the 100 degrees in the rotational direction of the photosensitive drum 1. Consequently, latent images at the Bk-developing position are shifted to the right side in the timing chart of FIG. 8 by the amount of: 180×π×(100÷360)=157 mm, or the amount of: 157÷200=0.785 second.

The operation of the Bk-developing unit 4Bk is similar to those of the M-developing unit 4m, the C-developing unit 4c and the Y-developing unit 4y. Moreover, because the M-developing unit 4m is disposed upstream of the Bk-developing unit 4Bk by the 33 degrees in the rotational direction of the photosensitive drum 1, the latent images at the M-developing position are shifted to the left side by the 0.261 second (by the 52 mm) in the timing chart of FIG. 8 with respect to the latent images at the Bk-developing position.

After that, the aforesaid operations are repeated with keeping the aforesaid relations.

However, the following disadvantages have been produced in the aforesaid related art configuration at some timing between the transmission of the driving of each of the developing units 4y, 4c, 4m and 4Bk.

Although the operation of each of the developing units 4y, 4c, 4m and 4Bk is performed as described above, the relations between each of the developing units 4y, 4c, 4m and 4Bk are now noticed. The timing of the turning on of the C-clutch 110c will be described. Immediately before the turning on of the C-clutch 110c, the M-developing unit 4m is in a state of pressure-contact, and the M-clutch 10m is in its turned-on state and the latent image M2 is being developed. FIG. 6 is referred while the following description is made. Driving from a drive motor (not shown) is transmitted to the timing belt 101, the input pulley 102, the input shaft 103, the distributing gear 104, the M-clutch gear 109m, the M-clutch 10m, the output shaft 111m, the output gear 112m and the sleeve gear 113m in the order, and thereby the drive motor drives the M-developing unit 4m to rotate it. In such a state, when the C-clutch 110c is turned on, the driving from the distributing gear 104 is transmitted to the C-clutch gear 109c, the C-clutch 110c, the output shaft 111c, the output gear 112c, and the sleeve gear 113c in the order. Then, the driving is to drive the C-developing unit 4c to rotate it.

At this time, the load and the inertia of the C-developing unit 4c are transmitted to the distributing gear 104 through the reverse path of the path at the time of the transmission of driving, and the transmitted load and the transmitted inertia instantaneously lowers the rotational speed of the distributing gear 104.

The lowering of the rotational speed of the distributing gear 104 is transmitted to the M-clutch gear 109m, the M-clutch 110m, the output shaft 111m, the output gear 112m and the sleeve gear 113m in the order. Finally, the speed of the M-developing unit 4m is lowered.

The M-developing unit 4m is developing the position thereof before 0.098 second (before 19.6 mm) from the trailing edge of the latent image M2 at this time. Consequently, when the rotational speed of the development sleeve of the M-developing unit 4m is lowered, the feeding of toner to the latent image M2 becomes uneven, and unevenness in a shape of lateral strips are produced at the corresponding positions on an image.

These disadvantages are not limited to the relations between the M-developing unit 4m and the C-developing unit 4c, and they are generated in any timing of the transmission of driving to one developing unit during the developing of a latent image by another developing unit.

In the C-developing unit 4c, the lowering of the rotational speed during the development of the trailing edge of the latent image C2 owing to the turn on of the Y-clutch 110y is produced at a time designated by a reference numeral (i) in FIG. 7 to generate lateral stripes. In the Bk-developing unit 4Bk, the lowering of the rotational speed during the development of the trailing edge of the latent image Bk2 owing to the turn on of the M-clutch 10m is produced at a time designated by a reference numeral (ii) in FIG. 8 to generate lateral stripes.

Because the developing positions of the Y-developing unit 4y and the Bk-developing unit 4Bk are sufficiently distant and there is no timing when two color clutches of the Y-clutch 110y and the Bk-clutch 110Bk are in their turned-on states at the same time between the Y-developing unit 4y and the Bk-developing unit 4Bk, no disadvantage such that the lateral stripes are produced is presented.

Accordingly, it is considerable that the diameter of the photosensitive drum 1 is enlarged to widen the intervals between latent images so that the lateral stripes are not produced. However, in this case, another problem such that the shape of the apparatus becomes large is presented.

Moreover, it is also considerable to thin out the rotations of the photosensitive drum 1 by a half rotation thereof to form the next latent image C1 after the formation of the latent images M1 and M2 (i.e. the latent image C1 in the related art is not formed, and the latent image C1 is formed at the position of the latent image C2 in the related art and the latent image C2 is formed at the position of the latent image Y1 in the related art). However, in this case, another problem such that the printing speed thereof decreases to the ⅔ of that of the related art is presented.

A method for performing the pressurization operation in the developing process and the clutch operations at high speeds would increase the shocks at the time of the pressurization to disturb the formation of latent images, and thereby image blurring would be caused. Besides, the necessity of the changes of the clutches 110m, 110c, 110y and 110Bk to be ones having a large capacity would be brought about, which would make the cost of the apparatus increase largely.

Anyway, for the escape of these disadvantages, it is necessary to employ a structure not to perform the transmission of driving to a developing unit while another developing unit is developing a latent image.

### SUMMARY OF THE INVENTION

One object of the present invention is to provide a rotating force transmitting apparatus capable of preventing the occurrence of a phenomenon such that, when the rotation of one of a first and a second rotary members is begun while the other of them is rotating, the rotational speed of the rotating rotary member is decreased.

Another object of the present invention is to provide an image forming apparatus capable of preventing the occurrence of the phenomenon such that, when the rotation of one of the first and the second rotary members is begun while the other of them is rotating, the rotational speed of the rotating rotary member is decreased.

A further object of the present invention is to provide an image forming apparatus capable of preventing a faulty image owing to the decrease of the rotational speed of a development rotary member to obtain a high quality image at a high printing speed without enlarging the shape of the apparatus and increasing the cost thereof.

The other objects, features and advantages of the present invention will become more apparent from the following description of the presently preferred exemplary embodiments of the invention taken in conjunction with the accompanying drawings.

### BRIEF DESCRIPTION OF THE DRAWINGS

FIG. 1 is a schematic front sectional view of a full color electrostatic copying machine being an image forming apparatus equipped with a rotating force transmitting apparatus according to the present invention in the apparatus main body thereof;

FIG. 2 is an enlarged view of the printer portion of the full color electrostatic copying machine of FIG. 1;

FIG. 3 is an expanded view of the rotating force transmitting apparatus of a first embodiment of the present invention;

FIG. 4 is an expanded view of the rotating force transmitting apparatus of a second embodiment of the present invention;

FIG. 5 is a schematic front view of the printer portion of a full color electrostatic copying machine being an image forming apparatus equipped with a conventional rotating force transmitting apparatus in the apparatus main body thereof;

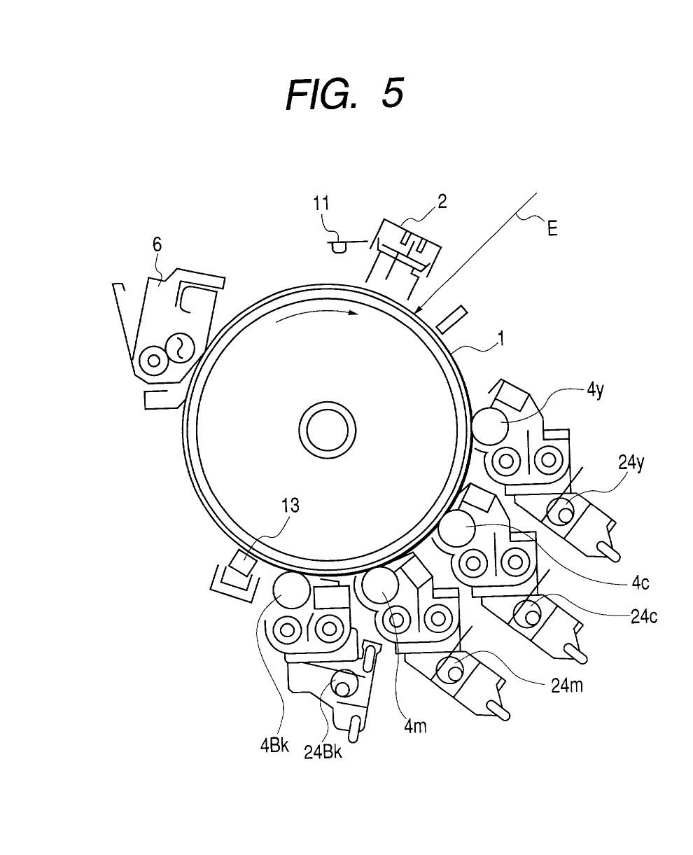

FIG. 6 is an expanded view of the conventional rotating force transmitting apparatus;

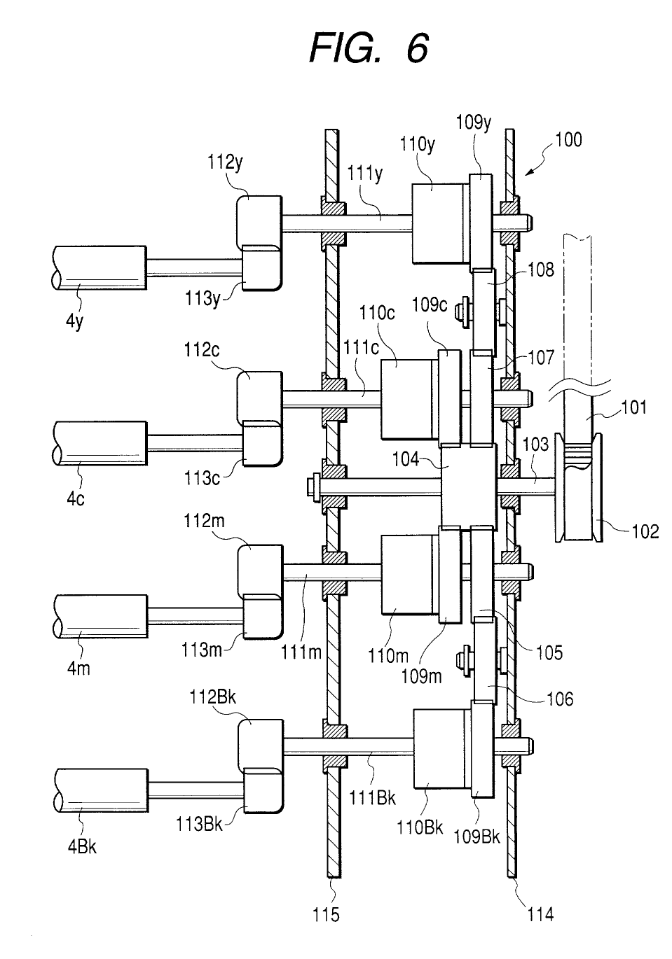

FIG. 7 is a part of a timing chart of the developing pressurization operations and the clutch operations of the conventional rotating force transmitting apparatus;

FIG. 8 is the other part of the timing chart of the developing pressurization operations and the clutch operations shown in FIG. 7, in which the waveforms indicated by reference characters A and B are succeeded by the waveforms indicated by the same reference characters A and B in FIG. 8; and

FIG. 9 is an enlarged view of a part of the waveforms in the timing chart of the developing pressurization operations and the clutch operations shown in FIG. 7.

### DETAILED DESCRIPTION OF THE PREFERRED EMBODIMENTS

Preferred Embodiments of the present invention will be described with reference to the accompanying drawings.

(Image Forming Apparatus)

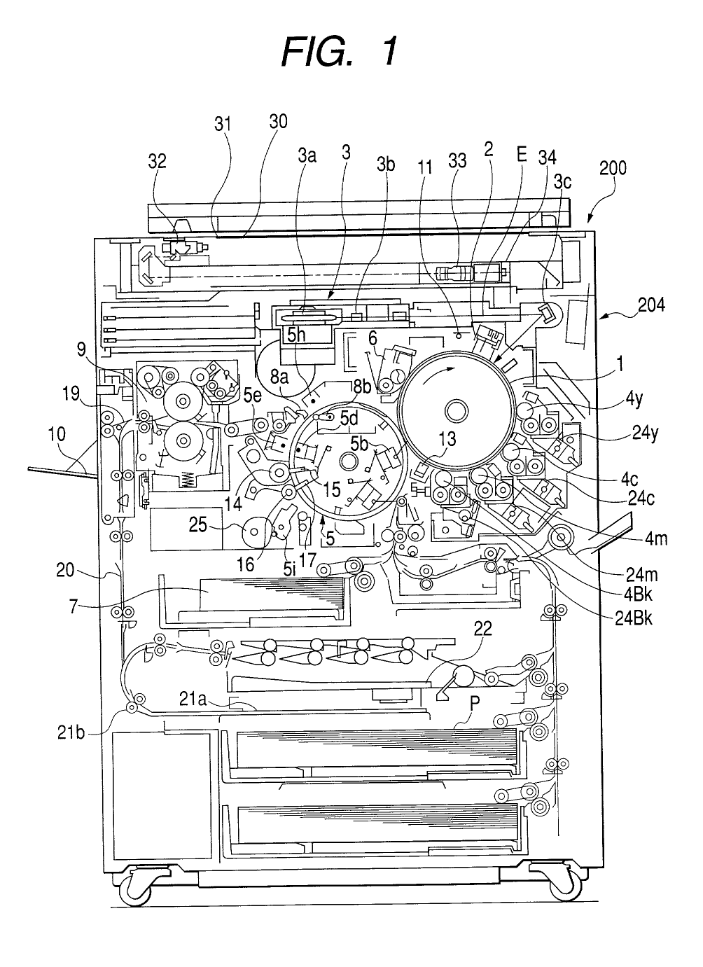

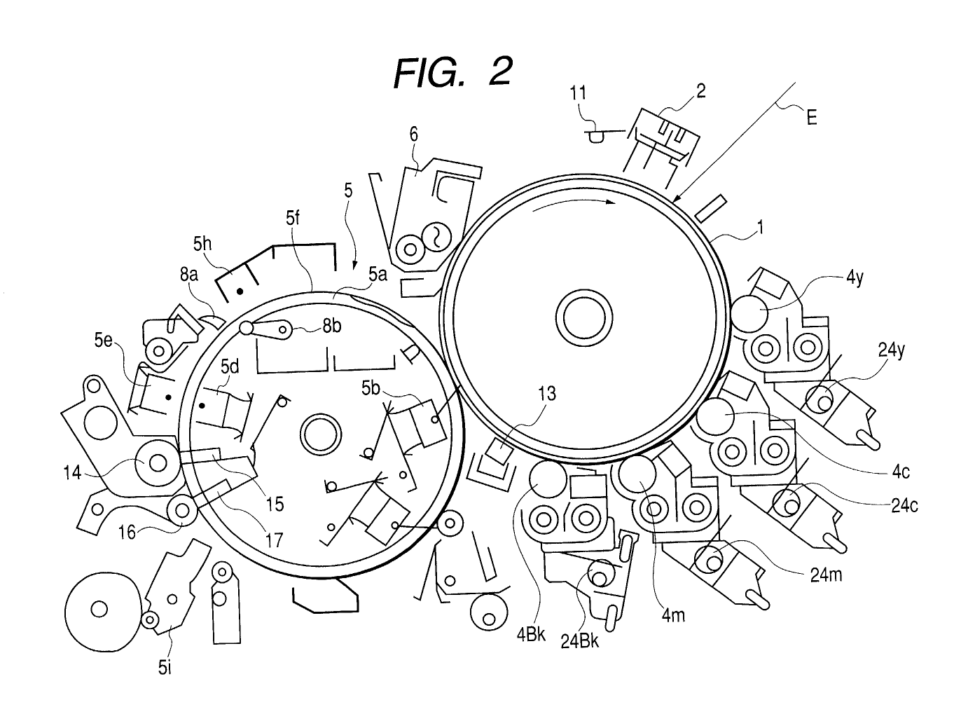

The main part of a full color electrostatic copying machine 200 being an example of an image forming apparatus will be described with reference to FIG. 1 and FIG. 2.

The full color electrostatic copying machine 200 is equipped with a color image reader portion (hereinafter referred to as a “reader portion”) for reading image information on an original at the upper part thereof and a digital image printer portion (hereinafter referred to as a “printer portion”) for recording an image on a recording medium on the basis of the image information from the reader portion at the lower part thereof.

As shown in FIG. 1, in the reader portion, an original 30 placed on an original glass stand 31 is exposed to be scanned by an exposure lamp ³², and a light image reflected by the original 30 is condensed by a lens 33. The condensed light beam reflected by the original 30 is obtained by a full color charge coupled device (CCD) sensor 34 as image signals separated into colors. The image signals separated into colors are transmitted to the printer portion after being processed by a video processing unit (not shown) through an amplifying circuit (not shown).

As shown in FIG. 1 and FIG. 2, the printer portion supports a photosensitive drum (image bearing member) 1 being an image bearing member rotatably in the direction indicated by the arrow. Around the photosensitive drum 1, a pre-exposure lamp 11, a corona charger 2, a laser exposure optical system 3, a Y-developing unit (development rotary member) 4y, a C-developing unit (development rotary member) 4c, an M-developing unit (development rotary member) 4m and a Bk-developing unit (development rotary member) 4Bk being four developing devices for different colors, means 13 for detecting a quantity of light on the photosensitive drum 1, a transferring apparatus 5, and a cleaning device 6 are disposed. Among these components, the photosensitive drum 1, the pre-exposure lamp 11, the corona charger 2, the laser exposure optical system 3, the four developing units 4y, 4c, 4m and 4Bk for different colors, and the like constitute image forming means. The Y-developing unit 4y is a developing unit for yellow. The C-developing unit 4c is a developing unit for cyan. The M-developing unit 4m is a developing unit for magenta. The Bk-developing unit 4Bk is a developing unit for black.

The laser exposure optical system 3 makes laser beam from a laser outputting portion (not shown) according to image signals from the reader portion reflect on a polygon mirror 3a to irradiate the photosensitive drum 1 through a lens 3b and a mirror 3c.

When an image is formed by the printer portion, the charger 2 uniformly charges the photosensitive drum 1 after the photosensitive drum 1 has rotated in the direction indicated by the arrow to eliminate residual charges on the outer periphery of the photosensitive dram 1 with the pre-exposure lamp 11. Then, latent images are formed on the photosensitive drum 1 by respective light images E of separated colors being irradiated on the photosensitive drum 1.

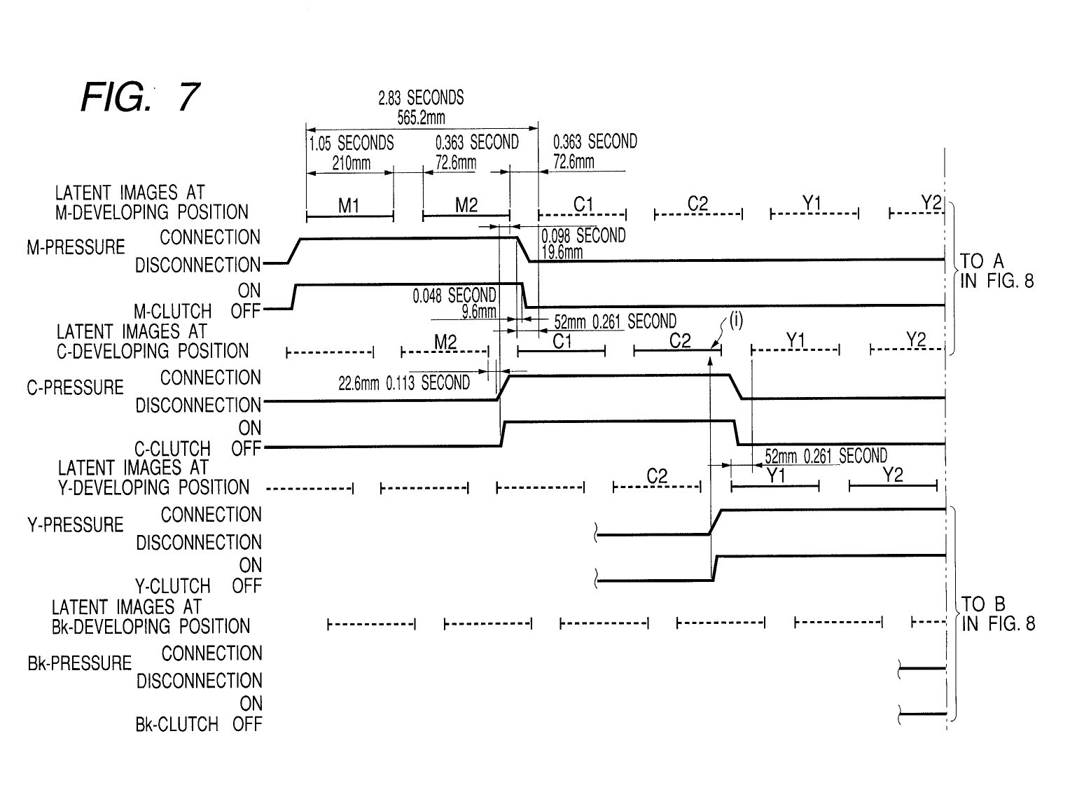

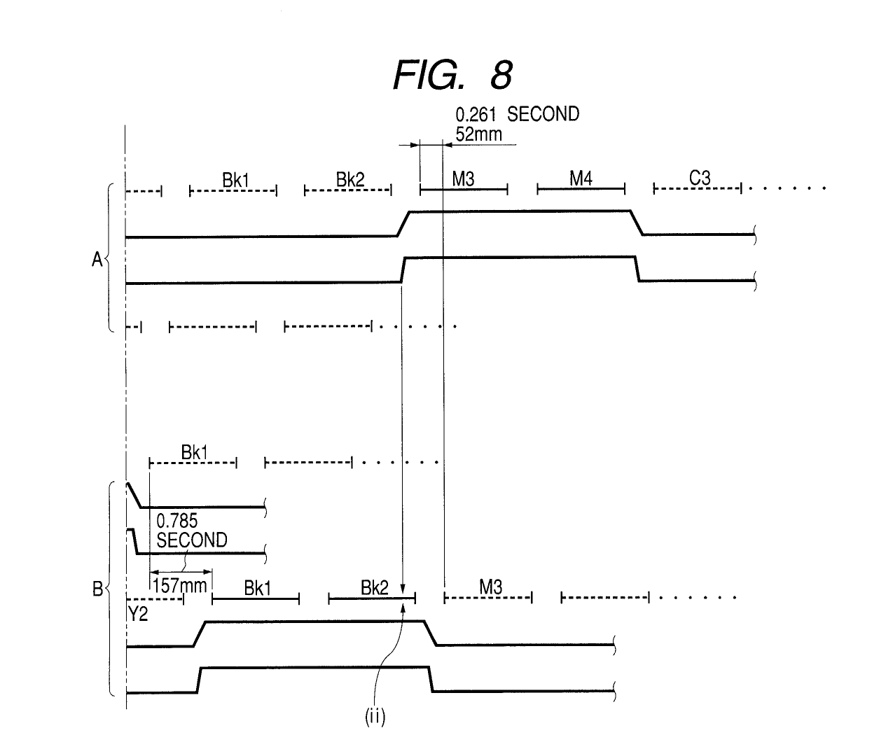

Next, the latent images on the photosensitive drum 1 are developed by the operations of the developing units 4y, 4c, 4m and 4Bk corresponding to respective separated colors, and the images of toner being a powder developer having a base composed of a resin and a pigment are formed on the photosensitive drum 1. Incidentally, the developing units 4y, 4c, 4m and 4Bk are configured to approach the photosensitive drum 1 selectively in response to each separated color by the operations of respective eccentric cams 24y, 24c, 24m and 24Bk. Moreover, the order of forming images is in the order of M, C, Y and Bk as shown in FIG. 7 and FIG. 8.

On the other hand, a recording material being a recording medium contained in a recording-material cassette 7 is fed to a transferring portion formed between the photosensitive drum 1 and the transferring apparatus 5 by the conveying system, and the toner images on the photosensitive drum 1 are transferred onto the recording material by the transferring apparatus 5. Incidentally, the transferring apparatus 5 of the present image forming apparatus includes a transferring drum 5a, an inside charger 5d and an outside charger 5e. In an opening region on the peripheral surface of the transferring drum 5a supported to be driven to rotate, a recording material bearing sheet 5f made of a dielectric is formed to be spread integrally in a cylindrical shape. Moreover, in the present image forming apparatus, a dielectric sheet such as a polycarbonate film or the like is used as the recording material bearing sheet 5f being a part for bearing a recording material.

When the transferring apparatus 5 rotates the drum shaped transferring drum 5a, a transferring charger 5b transfers the toner images on the photosensitive drum 1 to the recording material borne by the recording material bearing sheet 5f. In such a way, on the recording material electrostatically attracted to the recording material bearing sheet 5f and conveyed by the recording material bearing sheet 5f, a desired number of color images are transferred to form a full color image.

The full color image forming apparatus separates the recording material from the transferring drum 5a with a separation claw 8a, a separation pushing up roller 8b and a separation charger 5h after the transferring of the four color toner images is completed. The fixing process for the recording material is performed by a heating roller fixing unit 9, and the recording material is delivered to a delivery tray 10.

On the other hand, after the transferring process, residual toner remaining on the surface of the photosensitive drum 1 is cleaned by the cleaning device 6 to be fed to the image forming process again.

Moreover, in the case where images are formed on both sides of the recording material, the recording material is once lead into a transferring path 21a through a vertical conveying path 20 by being driven by a conveying path switching guide 19 after the fixing process of the recording material has performed through the fixing unit 9. After that, by the reverse rotation of a surface reverse roller 21b, the trailing edge of the recording material at the time of being fed is turned to be in the lead, and the turned recording material is withdrawn in the opposite direction to the fed direction to be contained in an intermediate tray 22. Then, images are again formed on the other surface of the recording material by the aforesaid image forming process.

Incidentally, the present image forming apparatus is equipped with a backup brush 15 opposed to a fur brush 14 with the recording material bearing sheet 5f put between them and a backup brush 17 opposed to an oil eliminating roller 16 with the recording material bearing sheet 5f put between them for preventing the scattering and the attachment of a powder such as toner on the recording material bearing sheet 5f of the transferring drum 5a, the attachment of oil on the recording material, and the like. The cleaning of the recording material bearing sheet 5f is performed before or after the formation of images. At the time of jamming (the clogging of recording materials), the cleaning is performed whenever it is necessary.

Moreover, the present image forming apparatus is configured such that, when an eccentric cam 25 is operated at a desired timing, a cam follower 5i formed integrally with the transferring drum 5 is operated to set the gap between the recording material bearing sheet 5f and the photosensitive drum 1 arbitrarily. For example, the present image forming apparatus is configured such that, when it is in a standby state or the power source thereof is off, the transferring drum 5a and the photosensitive drum 1 can be separated.

(Rotating Force Transmitting Apparatus of First Embodiment)

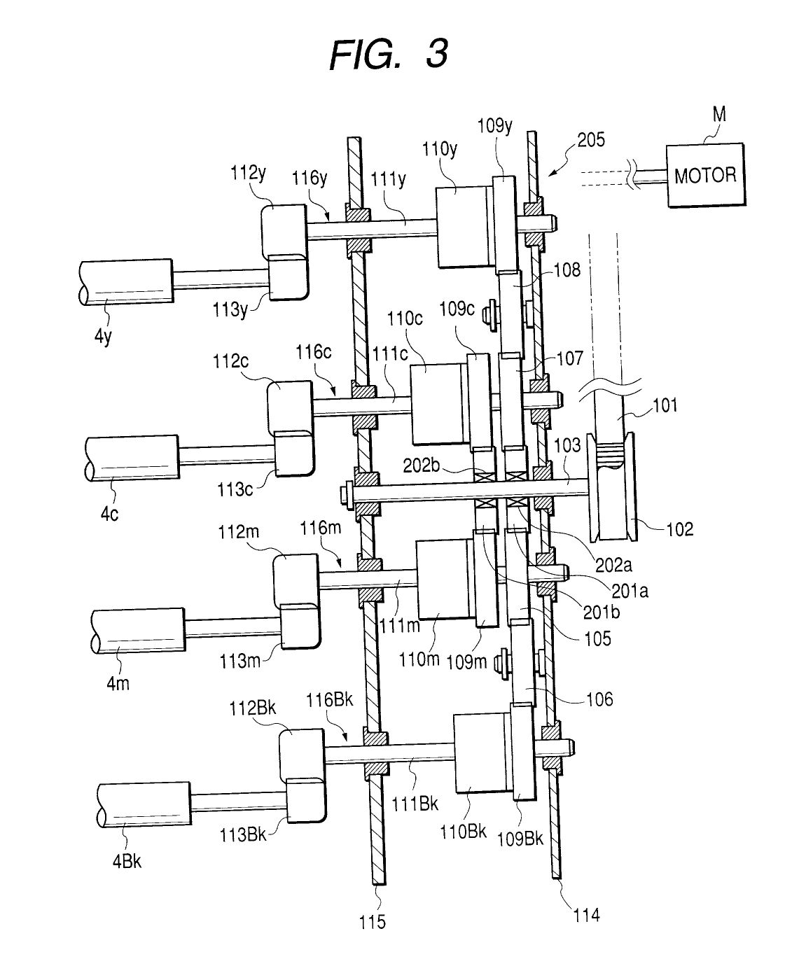

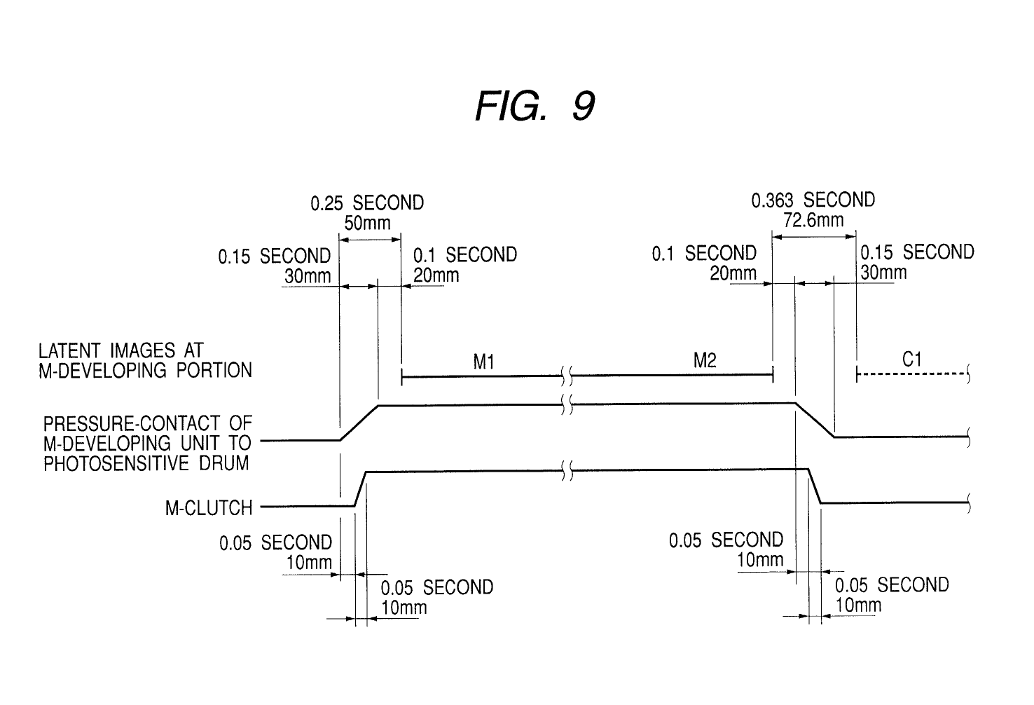

FIG. 3 is an expanded view of a rotating force transmitting apparatus 205 provided in the apparatus main body 204 of the full color copying machine 200 as the image forming apparatus employing an electrophotographic process. Incidentally, the present embodiment employs the image forming sequence based on the aforesaid flow charts shown in FIG. 7 to FIG. 9. Moreover, the rotating force transmitting apparatus according to the first embodiment and a second embodiment of the preset invention can be used by being equipped in not only the apparatus main body 204 of the full color electrostatic copying machine 200 but also the other image forming apparatuses such as a printer and the like.

In FIG. 3, a rotating force is transmitted from a common drive motor M (driving means) to an input pulley 102 (driving means) being a common driving rotary member, and an input shaft 103 (driving means) being a driving rotation shaft by a timing belt 101 (driving means).

One-way clutches (such as overrunning clutches, for example, sprag clutches) 202a and 202b as one-way rotating force transmitting means (permitting means) are provided on the input shaft 103. The one-way clutches 202a and 202b are configured to have gears 201a and 201b on their outer peripheries. The locking directions of the gears 201a and 201b are set in the direction in which, when the input shaft 103 is rotated in the direction to rotate the developing units 4y, 4c, 4m and 4Bk in their normal directions, the shaft 103 and the gears 201a and 201b are locked to transmit the rotations of the shaft 103 to the gears 201a and 201b. When it is conversely expressed, the direction is the direction such that, when the gears 201a and 201b are rotated in the direction of driving the developing units 4y, 4c, 4m and 4Bk to rotate them in their normal direction, the gears 201a and 201b become free from the shaft 103.

A rotating force is transmitted from the input shaft 103 to the gears 201a and 201b. The rotations of the gear 201a are transmitted to a Bk-clutch gear 109Bk through idler gears 105 and 106, and are further transmitted to a Y-clutch gear 109y through idler gears 107 and 108.

The rotations of the gear 201b are transmitted to an M-clutch gear 109m and a C-clutch gear 109c. Now, when an M-clutch 110m is turned on (namely, an output shaft 111m and the M-clutch gear 109m are connected to each other for transmitting a driving force), the rotating force of the drive motor M is transmitted to the development sleeve (a rotary member) of the M-developing unit 4m through the gear 201b, the M-clutch 110m, the output shaft 111m, an output gear 112m and a sleeve gear 113m coaxial with the development sleeve as a development rotary member, and the development sleeve is rotated. Moreover, when the M-clutch 110m is turned off (namely, the connection between the output shaft 111m and the M-clutch gear 109m is released for releasing the transmission of the driving force), the transmission of the rotating force from the drive motor M to the development sleeve is disconnected. A C-clutch, a Y-clutch and a Bk-clutch that will be described later have the same configuration.

When the C-clutch 110c is turned on, the rotating force of the drive motor M is transmitted to the development sleeve of the C-developing unit 4c through the gear 201b, the C-clutch 110c, an output shaft 111c, an output gear 112c and a sleeve gear 113c coaxial with the development sleeve as a development rotary member, and the development sleeve is rotated.

When the Y-clutch 110y is turned on, the rotating force of the drive motor M is transmitted to the development sleeve of the Y-developing unit 4y through the gear 201a, the idle gears 107 and 108, the Y-clutch gear 109y, the Y-clutch 110y, an output shaft 111y, an output gear 112y and a sleeve gear 113y coaxial with the development sleeve as a development rotary member, and the development sleeve is rotated.

Then, when the Bk-clutch 110Bk is turned on, the rotating force of the drive motor M is transmitted to the development sleeve of the Bk-developing unit 4Bk through the gear 201a, the idle gears 105 and 106, the Bk-clutch gear 109Bk, the Bk-clutch 110Bk, an output shaft 111Bk, an output gear 112Bk and a sleeve gear 113Bk coaxial with the development sleeve as a development rotary member, and the development sleeve is rotated.

The operations of the rotating force transmitting apparatus 205 are described with the notice of the timing of the turning on of the Y-clutch 110y (for example, the timing at the position (i) in FIG. 7) while the C-developing unit 4c is performing development.

Immediately before the turning-on of the Y-clutch 110y, the C-developing unit 4c is in a state of pressure-contact, and the C-clutch 110c is in its turned-on state and a latent image C2 is being developed. That is, in FIG. 3, the drive motor M is rotating, and the rotations of the drive motor M are transmitted to the timing belt 101, the input pulley 102, the input shaft 103, the gear 201b, the C-clutch gear 109c, the C-clutch 110c, the output shaft 111c, the output gear 112c and the sleeve gear 113c in the order, and thereby the drive motor M drives the C-developing unit 4c to rotate it.

In such a state, when the Y-clutch 110y is turned on, the rotations from the gear 201a are transmitted to the idler gears 107 and 108, the Y-clutch gear 109y, the Y-clutch 110y, the output shaft 111y, the output gear 112y, and the sleeve gear 113y in the order. Then, the Y-developing unit 4y begins to rotate.

At this time, the load and the inertia of the Y-developing unit 4y are transmitted to the gear 201a and the input shaft 103 through the reverse path of the path at the time of the transmission of driving, and thereby the rotational speed of the input shaft 103 is instantaneously lowered. On the other hand, the rotational speed of the gear 201b remains the same so far owing to the inertia including the C-developing unit 4c on the downstream side. That is, the rotational speed of the gear 201b becomes faster than that of the input shaft 103.

At this time, the rotational direction of the gear 201b is directed to the direction permitting the preceding rotation of the C-developing unit 4c (or the direction in which the gear 201b becomes free from the input shaft 103). Consequently, sliding is generated between the input shaft 103 and the gear 201b by the one-way clutch 202b. Owing to the sliding, the decrease of the rotational speed of the C-developing unit 4c, which is performing development, is very little. After that, when the input shaft 103 returns to a predetermined speed, the gear 201b and the input shaft 103 enter in their locked states, and thereby rotations are transmitted.

As a result, the decrease of the rotational speed of the C-developing unit 4c is suppressed to a degree such that the feeding of toner to latent images is not influenced by that, and good images having no unevenness such as lateral stripes can be obtained.

The aforesaid operation is not limited to the relations between two colors of cyan (C) and yellow (Y).

The operation can also be performed between the two colors of black (Bk) and magenta (M) similarly (for example, at the timing of (ii) in FIG. 8).

Because the image forming apparatus constructs the connection of the C-clutch 110c and the Y-clutch 110y through the gears 201a and 201b, and also the connection of the Bk-clutch 110Bk and the M-clutch 110m through the gears 201a and 201b, instantaneous decreases of speeds can be absorbed by the sliding of the one-way clutches 202a and 202b to obtain good images.

(Rotating Force Transmitting Apparatus of Second Embodiment)

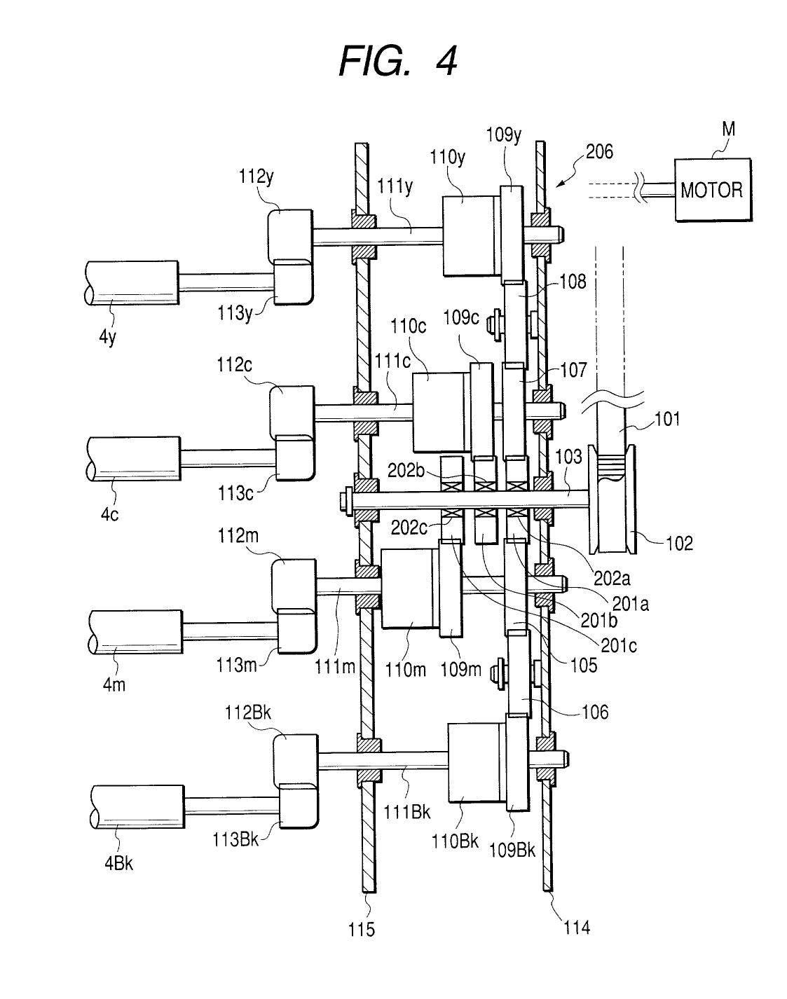

The aforesaid rotating force transmitting apparatus 205 of the first embodiment does not cope with the decrease of the speed of the C-developing unit 4c owing to the turning-on of the C-clutch 110c of the C-developing unit 4c while the M-developing unit 4m is performing development. Accordingly, a rotating force transmitting apparatus 206 according to the second embodiment, which is shown in FIG. 4, is configured in order to deal with the decrease of the speed between the two colors.

In FIG. 4, one-way clutches (one-direction rotating force transmitting means) 202a, 202b and 202c are provided on the input shaft 103, and gears 201a, 201b and 201c are provided on the outer peripheries of the one-way clutches 202a, 202b and 202c, respectively. The gear 201a transmits rotations of the drive motor M to the Y-developing unit 4y and the Bk-developing unit 4Bk. The gear 201b transmits rotations of the drive motor M to the C-developing unit 4c. The gear 201c transmits rotations of the drive motor M to the M-developing unit 4m.

The locking directions in the gears 201a, 201b and 201c are the same as those of the first embodiment. That is, the locking directions are the directions in which, when the developing units 4y, 4c, 4m and 4Bk are driven to rotate in their normal directions, the input shaft 103 is locked.

The operations of the rotating force transmitting apparatus 206 are described with the notice of the timing of the turning-on of the C-clutch 110c while the M-developing unit 4m is performing development.

Immediately before the turning-on of the C-clutch 110c, the M-developing unit 4m is in a state of pressure-contact, and the M-clutch 110m is in its turned-on state and a latent image M2 is being developed. In FIG. 4, the driving from the drive motor M is transmitted to the timing belt 101, the input pulley 102, the input shaft 103, the gear 201c, the M-clutch gear 109m, the M-clutch 110m, the output shaft 111m, the output gear 112m and the sleeve gear 113m in the order, and thereby the drive motor M drives the M-developing unit 4m to rotate it.

In such a state, when the C-clutch 110c is turned on, the driving from the gear 201b is transmitted to the C-clutch gear 109c, the C-clutch 110c, the output shaft 111c, the output gear 112c, and the sleeve gear 113c in the order. Then, the C-developing unit 4c is driven to rotate.

At this time, the load and the inertia of the C-developing unit 4c are transmitted from the gear 201b to the input shaft 103 through the reverse path of the path at the time of the transmission of driving, and thereby the rotational speed of the input shaft 103 is instantaneously lowered.

On the other hand, the rotational speed of the gear 201c remains the same so far (the speed during the development) owing to the inertia including the M-developing unit 4m on the downstream side.

That is, the rotational speed of the gear 201c becomes faster than that of the input shaft 103. At this time, the rotational direction of the gear 201c is directed to the direction permitting the preceding rotation of the M-developing unit 4m (or the direction in which the gear 201c becomes free from the input shaft 103). Consequently, sliding is generated between the input shaft 103 and the gear 201c. Owing to the sliding, the decrease of the rotational speed of the M-developing unit 4m, which is performing development, is very little. After that, when the input shaft 103 returns to a predetermined speed, the gear 201c and the input shaft 103 enter in their locked states again, and thereby the driving are transmitted.

As a result, the decrease of the rotational speed of the M-developing unit 4m is suppressed to a degree such that the feeding of toner to latent images is not influenced by that, and good images having no unevenness such as lateral stripes can be obtained.

The aforesaid operation is similarly performed between the two colors of cyan (C) and yellow (Y) (for example, at the position (i) in FIG. 7), and between the two colors of black (Bk) and magenta (M) (for example, at the position (ii) in FIG. 8).

Because the image forming apparatus constructs the connection of the M-clutch 110m and the C-clutch 110c through the gears 201b and 201c, and the connection of the C-clutch 110c and the Y-clutch 110y through the gears 201a and 201b, and further the connection of the Bk-clutch 110Bk and the M-clutch 110m through the gears 201a and 201c, instantaneous decreases of speeds can be absorbed by the sliding of the one-way clutches 202a, 202b and 202c to obtain good images.

Incidentally, because the Bk-developing unit 4Bk and the Y-developing unit 4y are distant from each other and the turning-on timing of the Bk-clutch 110Bk and turning-on timing of the Y-clutch 110y do not interfere to each other, the Bk-clutch gear 109Bk and the Y-clutch gear 109y are disposed in series. However, if the turning-on timing of the Bk-clutch 110Bk and turning-on timing of the Y-clutch 110y interfere to each other, a one-way clutch with a gear may be added by further shifting the driving systems in thrust directions.

As described above, according to the aforesaid embodiments, when the rotation of one development sleeve among a plurality of development sleeves as rotary members (development rotary members) is begun while another development sleeve is rotating for development, the disturbance (or the decrease) of the rotational speed of the development sleeve that has already been rotating owing to the beginning of the rotation of the development sleeve that is to be rotated afterward can be prevented, and the rotational speed of the development sleeve that has already been rotating can remains the same.

According to such an image forming apparatus, a high quality image without any inferior image quality (lateral stripes) owing to the speed changes of the development sleeves can be obtained at a high printing speed (image forming speed) without enlarging the size of the apparatus and increasing the costs thereof.

Although the invention has been described in its preferred form with a certain degree of particularity, obviously many changes and variations are possible therein. It is therefore to be understood that the present invention may be practiced than as specifically described herein without departing from scope and the sprit thereof.

What is claimed is:

1. A rotating force transmitting apparatus comprising:
first and second transmitting means for transmitting rotating forces to a first and a second rotary members, wherein said first and said second transmitting means include a first and a second clutches for intermittently transmitting the rotating forces;
common driving means for imparting the rotating forces to said first and said second transmitting means, wherein said second clutch can be switched from a turned-off state thereof to a turned-on state thereof for rotating said second rotary member when said first rotary member is rotating with said first clutch being turned on; and
permitting means for permitting a transmission of a rotating force only in a normal rotational direction of said driving means to said first transmitting means.

2. A rotating force transmitting apparatus according to claim 1, wherein said permitting means includes an overrunning clutch.

3. A rotating force transmitting apparatus according to claim 2, wherein said overrunning clutch includes a gear rotatable only in the normal rotational direction.

4. A rotating force transmitting apparatus according to claim 2 or 3, wherein said driving means includes a driving source, a drive rotation shaft provided with said overrunning clutch, and drive transmitting means for transmitting a rotating force of said driving source to said drive rotation shaft.

5. An image forming apparatus comprising:
first and second transmitting means for transmitting rotating forces to a first and a second development rotary members, wherein said first and said second transmitting means include a first and a second clutches for intermittently transmitting the rotating forces;
common driving means for imparting the rotating forces to said first and said second transmitting means, wherein said second clutch can be switched from a turned-off state thereof to a turned-on state thereof for rotating said second development rotary member during a development operation in which said first development rotary member is rotating with said first clutch being turned on; and
permitting means for permitting a transmission of a rotating force only in a normal rotational direction of said driving means to said first transmitting means.

6. An image forming apparatus according to claim 5, wherein said permitting means includes an overrunning clutch.

7. An image forming apparatus according to claim 6, wherein said overrunning clutch includes a gear rotatable only in the normal rotational direction.

8. An image forming apparatus according to claim 6 or 7, wherein said driving means includes a driving source, a drive rotation shaft provided with said overrunning clutch, and drive transmitting means for transmitting a rotating force of said driving source to said drive rotation shaft.

9. An image forming apparatus according to claim 5, wherein a commencement of a development operation of said second development rotary member is enabled during the development operation of said first development rotary member.

10. An image forming apparatus according to claim 9, wherein said first and said second development rotary members bear developers to carry the developers.

11. An image forming apparatus according to claim 10, wherein said first and said second development rotary members execute the development operations to a common image bearing member.
